(19) United States
(12) Patent Application Publication
(10) Pub. No.: US 2026/0134050 A1
(43) Pub. Date: May 14, 2026

(54) INDUSTRIAL ASSISTANCE PROMPT GENERATION WITH QR CODE DRIVEN DATA RETRIEVAL

(71) Applicant: Rockwell Automation Technologies, Inc., Mayfield Heights, OH (US)

(72) Inventors: Kurt D. Sneen, Park City, UT (US); Jonathan A. Mills, Mayfield Heights, OH (US)

(21) Appl. No.: 18/948,100

(22) Filed: Nov. 14, 2024

(51) Int. Cl. G06F 16/955; G06F 16/93; G06F 16/9538; G06K 7/14

(52) U.S. Cl. CPC G06F 16/9554; G06F 16/93; G06F 16/9538; G06K 7/1417

(57) ABSTRACT

The disclosure describes an application service that receives a user query and a catalog number of an industrial automation device. The catalog number is obtained by the user device by scanning a quick-response (QR) code affixed to the industrial automation device. The application service retrieves, based on the catalog number, documentation associated with the industrial automation device. For example, a specific domain associated with the industrial automation device may include the documentation. Using the documentation, the application service may generate an assistance prompt for a general artificial intelligence (GAI) model. The assistance prompt may task the GAI model with generating a response to the user query and may include the documentation as context. The application service transmits the GAI model response to the user device for display.

### CROSS-REFERENCE TO RELATED APPLICATIONS

This U.S. Patent Application is related to co-pending U.S. Patent Application titled “GUIDED WORKFLOWS AND PREREQUISITE EXTRACTION FOR PERFORMING MAINTENANCE ON AUTOMATION DEVICES,” Attorney Docket Number 2024P-223-US, filed concurrently, the contents of which are incorporated herein in their entirety for all purposes.

This U.S. Patent Application is related to co-pending U.S. Patent Application titled “INDUSTRIAL AUTOMATION GENERATIVE ARTIFICIAL INTELLIGENCE ASSISTANCE INTERFACE WITH INTEGRATED ORGANIZATION CAPABILITIES,” Attorney Docket Number 2024P-224-US, filed concurrently, the contents of which are incorporated herein in their entirety for all purposes.

This U.S. Patent Application is related to co-pending U.S. Patent Application titled “SYNTHESIZING DOMAIN-BASED RESPONSES IN INDUSTRIAL AUTOMATION SYSTEMS LEVERAGING GENERATIVE ARTIFICIAL INTELLIGENCE,” Attorney Docket Number 2024P-227-US, filed concurrently, the contents of which are incorporated herein in their entirety for all purposes.

### BACKGROUND

Industrial operators regularly perform tasks on new industrial automation devices, such as installation, configuration, or maintenance. These procedures often vary depending on the specific model of the device. For example, different models may have varying input/output (I/O) configurations, voltage ratings, enclosure types, frame size, and so forth, resulting in distinct wiring requirements during installation. To execute the appropriate procedure for a given device model, operators often need to sift through extensive documentation to locate the relevant instructions.

Furthermore, the specific device model may not always be readily apparent to an industrial operator performing the tasks (e.g., when a new industrial automation device has been unboxed and is ready for installation). Even if the operator knows the device family, a given device family may encompass several different models, each having a distinct set of features. Inefficiencies arise when the operator needs to search through files to determine the correct model, and through technical documentation to find the appropriate procedures. Moreover, if an operator follows the wrong procedures due to misidentification, they may incorrectly configure or install the device, which could result in equipment malfunction, damage, or safety hazards.

### SUMMARY

The disclosure describes an application service that tailors prompts for a general artificial intelligence (GAI) model by retrieving device-specific documentation based on a catalog number for an industrial automation device. The catalog number is obtained by a user device by scanning a quick-response (QR) code affixed to the industrial automation device. The response generated by the GAI model is tailored to the specific device scanned by the user, and the user may thus obtain assistance tailored to a specific device by simply scanning a QR code, alleviating the above-described issues.

A computer-implemented method for operating an application service according to some implementations includes receiving, at the application service and from a user device, a catalog number of an industrial automation device and a user query. The catalog number is obtained via a graphical user interface (GUI) executing on the user device by scanning a quick-response (QR) code affixed to the industrial automation device. The user query requests assistance with respect to the industrial automation device. The method further includes retrieving, based on the catalog number, documentation associated with the industrial automation device. The method further includes generating an assistance prompt designed to elicit a response from a general artificial intelligence (GAI) model. The assistance prompt tasks the GAI model with generating a response to the user query. The assistance prompt includes the documentation. The method further includes transmitting the response to the user device for display via the GUI.

The method further includes selecting, based on the catalog number, a device-specific domain from a group of domains. Each of the domains is directed to a specific aspect of an industrial automation environment. The method further includes retrieving the documentation by submitting a request for the documentation to the device-specific domain.

The method further includes receiving, at the application service and from the user device, a serial number for the industrial automation device. The serial number is obtained by scanning the QR code. The method further includes adding an entry for the industrial automation device to a device list comprising a plurality of entries for industrial automation devices a user has interacted with. The method further includes transmitting the device list to the user device for display via the GUI.

In some implementations, the user query is a request for assistance performing maintenance on the industrial automation device. In some implementations, the method further includes transmitting, to the user device in response to the user query, instructions to display a prompt to scan the QR code. Receiving the catalog number may be in response to the prompt to scan the QR code.

In some implementations, the user query includes one or more of: a request for assistance performing maintenance on the industrial device, a request for assistance installing the industrial automation device, and a request for assistance configuring the industrial automation device.

In some implementations, the method further includes transmitting the documentation to the user device for display via the GUI. The documentation includes at least a portion of one or more of: a technical sheet for the industrial automation device, a programming manual for the industrial automation device, a troubleshooting guide for the industrial automation device, an installation guide for the industrial automation device, and a user training manual for the industrial automation device.

In some implementations, the QR code encodes a catalog number for the industrial automation device, a serial number of the industrial automation device, and a device type for the industrial automation device.

These and other features and aspects of various examples may be understood in view of the following detailed discussion and accompanying drawings.

### BRIEF DESCRIPTION OF THE DRAWINGS

FIG. 1 illustrates an industrial automation environment in an implementation.

FIG. 2 illustrates a user device in an implementation.

FIG. 3 illustrates an application service in an implementation.

FIG. 4 illustrates a domain in an implementation.

FIG. 5 illustrates a process for QR code-driven response generation in an implementation.

FIG. 6 illustrates an operational sequence in an implementation.

FIGS. 7A-7D illustrate user interfaces in an implementation.

FIG. 8 illustrates a computing system suitable for implementing the various operational environments, architectures, environments, processes, scenarios, sequences, and frameworks discussed below with respect to the other Figures.

### DETAILED DESCRIPTION

When an industrial operator performs tasks on an industrial automation device (such as installation, configuration and maintenance), they must first identify the specific model of the device to ensure they follow the correct procedure. Typically, this involves consulting technical documentation associated with the device, which can be a cumbersome process due to the vast amount of documentation available for various device models. Often, procedures for multiple models are consolidated within the same manual, requiring the operator to sift through mixed information to locate the relevant instructions. The process is further complicated when the specific device model is not immediately apparent to the operator, such as when devices are unboxed on the factory floor and are ready for installation without visible identifying features. Even if the operator knows the general device family, such as the PowerFlex 755T series, this family may encompass several specific models, each with distinct configurations, including differences in voltage ratings, I/O configurations, enclosure types, and frame size.

Without accurate identification, operators risk applying incorrect procedures, which may lead to improper wiring, configuration errors, or incompatible voltage settings. These errors not only result in operational delays and inefficiencies but can also cause equipment malfunctions, damage to the device, and significant safety hazards, compromising both personnel safety and production uptime.

The disclosure describes an industrial automation environment where QR codes are affixed to industrial automation devices. These QR codes encode information such as the catalog number, serial number, and the device type of the devices. An industrial operator can scan the QR code using a user device, which extracts and identifies the catalog number, serial number, and device type. The operator may then submit a query related to the device (e.g., “What are the wiring requirements for my device?”). The user device transmits both the catalog number and the user query to an application service designed to provide industrial assistance via a chatbot interface.

The application service retrieves documentation associated with the industrial automation device based on the catalog number. Since the catalog number corresponds to a specific device model, the application service accesses the relevant documentation for that particular model. It then generates an assistance prompt for a general artificial intelligence (GAI) model, including the retrieved documentation and the user query, to task the GAI model with formulating a response. After the application service receives the response from the GAI model, it transmits the response back to the user device for display. This process enables the user to receive instructions specifically tailored to the scanned device model, leveraging the information provided by the QR code to accurately identify the device.

The disclosed system provides several technical effects and advantages, particularly in enhancing the efficiency and accuracy of industrial automation processes. By leveraging QR code technology to encode and retrieve device-specific information (such as catalog numbers, serial numbers, and device types), the system minimizes the time and effort required for operators to identify and maintain devices. This automation reduces the potential for human error, ensuring that the correct procedures are followed for each specific device model. The application service dynamically retrieves and utilizes relevant data, enabling the GAI model to generate context-aware responses. The system may also result in improved computer resource efficiency. Specifically, the retrieval of device-specific information ensures that only relevant data is transmitted and processed by the application service, rather than sifting through irrelevant information.

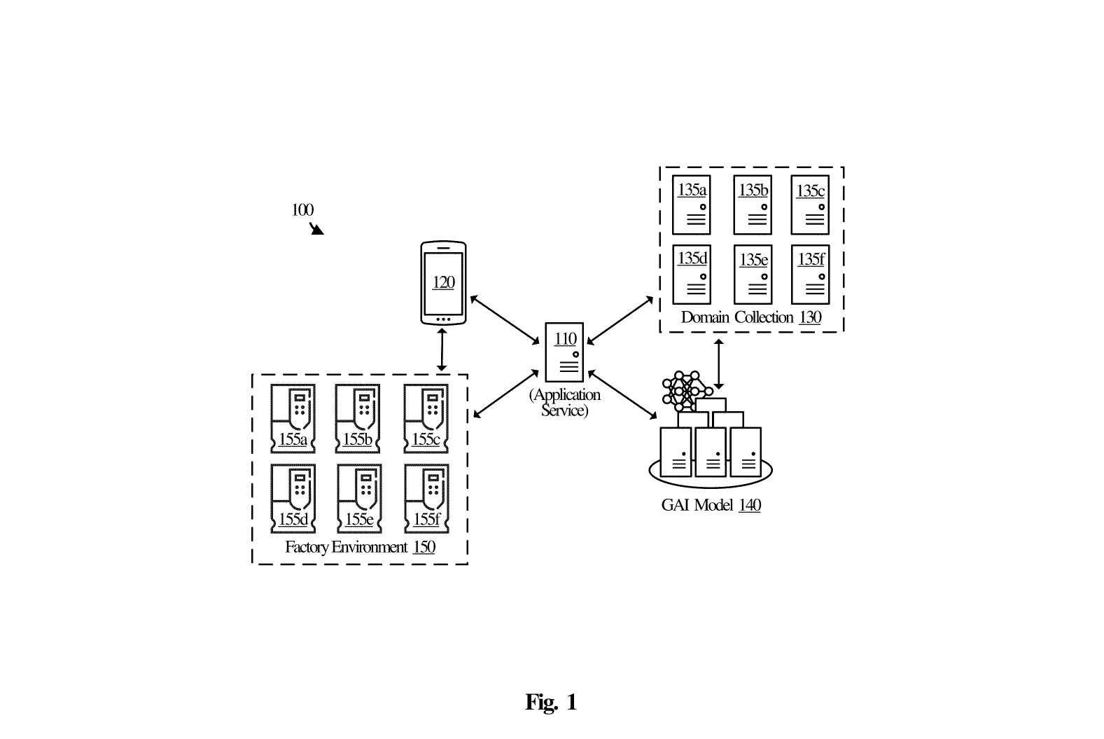

FIG. 1 illustrates industrial automation environment 100 in an implementation. Industrial automation environment 100 includes application service 110, user device 120, domain collection 130, GAI model 140, and factory environment 150. Application service 110 is in communication with user device 120, domain collection 130, GAI model 140, and factory environment 150. User device 120 is in communication with application service 110 and factory environment 150. Domain collection 130 is in communication with GAI model 140.

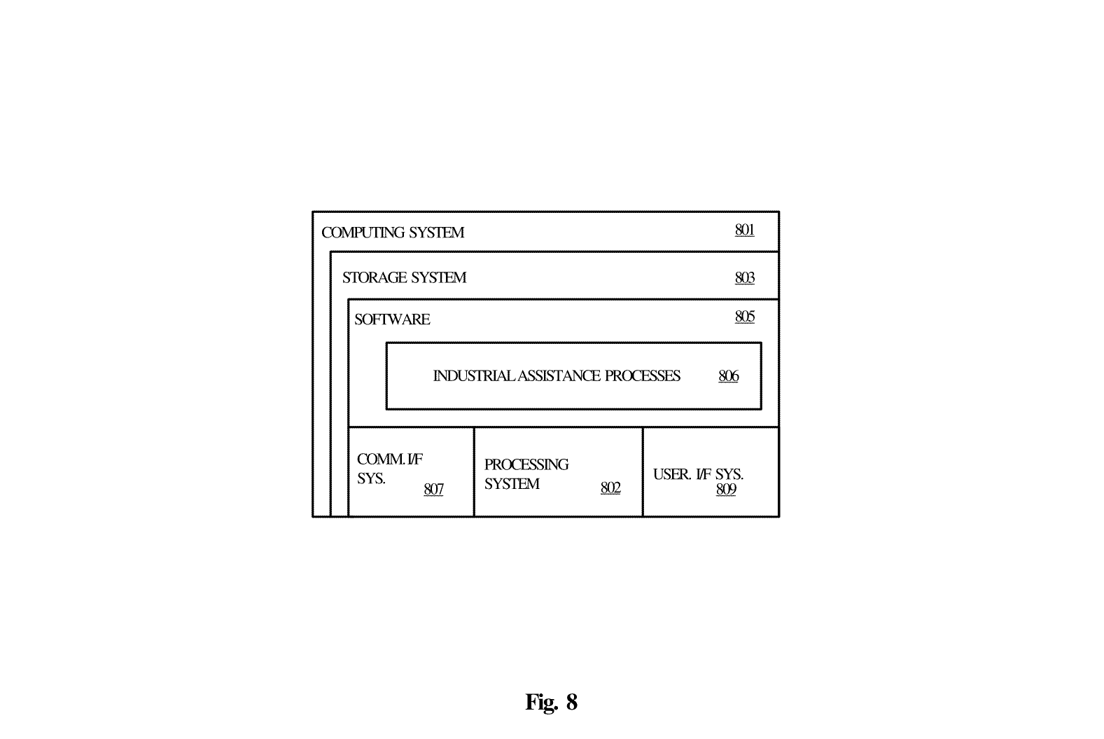

Application service 110 is a service for providing industrial assistance to users. Application service 110 may include software operating on one or more servers, which may be represented by computing system 801 of FIG. 8. In other implementations, application service 110 may be a cloud-based service. Application service 110 may be hosted by an industrial manufacturer in some implementations. Specifically, application service 110 may be provided to assist customers (e.g., a user on user device 120) in the execution of various tasks.

Application service 110 is configured to leverage GAI model 140 to enable users (e.g., on user device 120) to interact with a “chatbot” with which a user may submit queries and receive responses. Application service 110 receives these queries and prompts GAI model 140 to generate the responses, as described in greater detail herein. These queries may include requests for guided workflows for maintenance tasks, as well as natural language queries (e.g., “How do I install my PowerFlex 755T?”).

In some implementations, application service 110 selects one or more domains 135 from domain collection 130 based on the submitted queries. Application service 110 may select the domains 135a-135f using various methods. For example, where the query is a request for a guided workflow, application service 110 may select a device-specific domain 135 based on a device-type identified in the request. In another scenario, application service 110 may make the selection based on a QR code scan by user device 120, as discussed in greater detail in relation to domain selection module 310 below. In other scenarios, application service 110 may select a domain 135 by prompting GAI model 140 to select one or more domains 135 based on the user-submitted query.

Where the query is a request for a guided workflow for maintenance tasks, application service 110 may retrieve device-specific documentation from a device-specific domain 135 to generate assistance prompts for GAI model 140. The assistance prompts task GAI model 140 with generating a list of steps for performing the maintenance, a list of prerequisites for performing the maintenance, and a list of safety precautions for performing the maintenance. Upon receiving a response from GAI model 140, application service 110 transmits the guided workflow information to user device 120 for display.

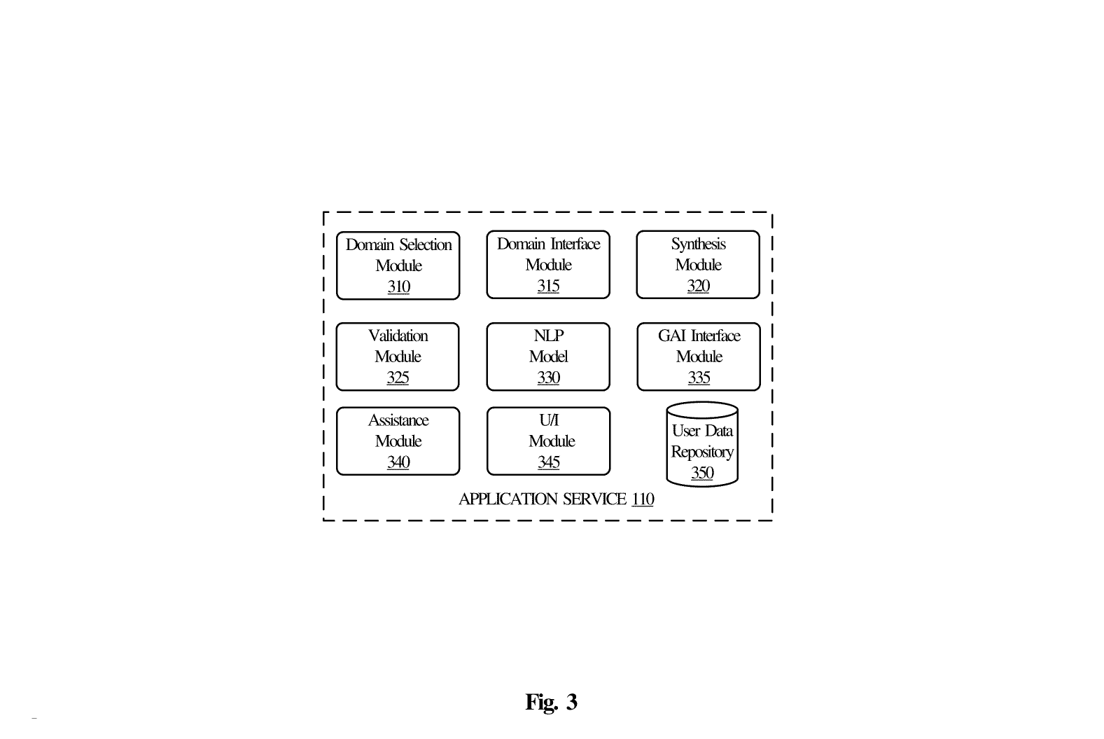

Application service 110 is also configured to manage user data in a user data repository, such as user data repository 350 of FIG. 3. The user data may include a list of devices (e.g., industrial automation devices 155a-155f) that the user has interacted with. Application service 110 may also store historical conversations between the user and the chatbot. Application service may also store identifications of which conversations and responses have been pinned by the user on user device 120, as discussed in greater detail with respect to FIG. 3 below.

User device 120 is a device utilized by users in industrial automation environment 100 to obtain industrial assistance. User device 120 may be a cell phone, tablet, laptop, human interface module (HIM), personal computer, or any other device capable of interfacing with application service 110. User device 120 may be represented by computing system 801 in FIG. 8. While one user device 120 is shown in FIG. 1 for simplicity, industrial automation environment 100 may include many user devices 120, with multiple users interacting with application service 110.

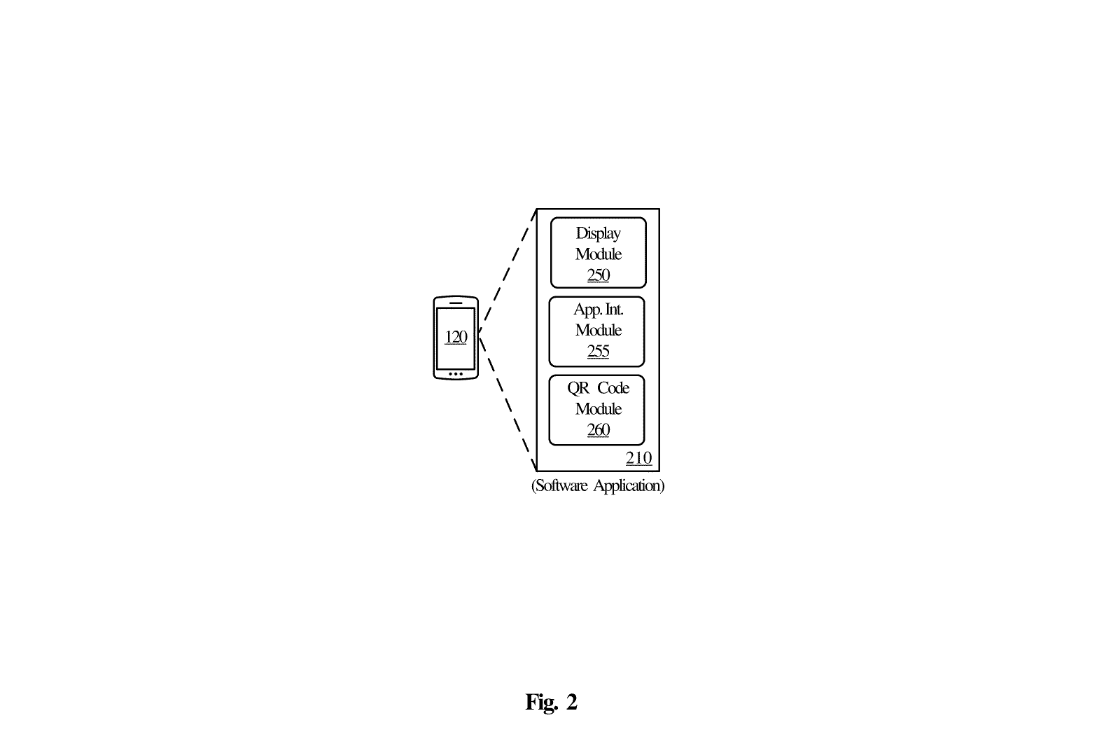

User device 120 may run device applications that interact with application service 110. For example, device applications running on user device 120 may include a software application (i.e., software application 210 described below in the discussion of FIG. 2), in which a user may interact with a chatbot by submitting queries such as natural language requests and requests for guided workflows. In some implementations, application service 110 may be a web-based application allowing user access via a web-browser. In either case, the user may submit queries and view responses from application service 110 on a user interface of user device 120.

Domain collection 130 is representative of a collection of domains 135a, 135b, 135c, 135d, 135e, 135f (collectively, “domains 135”) in industrial automation environment 100. While six domains 135 are shown in FIG. 1 for simplicity, it is noted that domain collection 130 may include any number of domains 135. Each domain 135 may include software operating on one or more servers, which may be represented by computing system 801 of FIG. 8.

Domains 135 are services configured to provide assistance with respect to specific aspects of the industrial automation environment 100. For example, each model of device (e.g., PowerFlex 755T) may have an associated domain 135 directed to that model. Some domains 135 may be customer-specific domains storing customer specific information (e.g., design preferences and customer-specific safety precautions). Various tasks (e.g., industrial control logic generation) may also have an associated domain 135. Accordingly, domain collection 130 as a whole is capable of providing aid in a wide range of needs that arise in industrial automation environment 100.

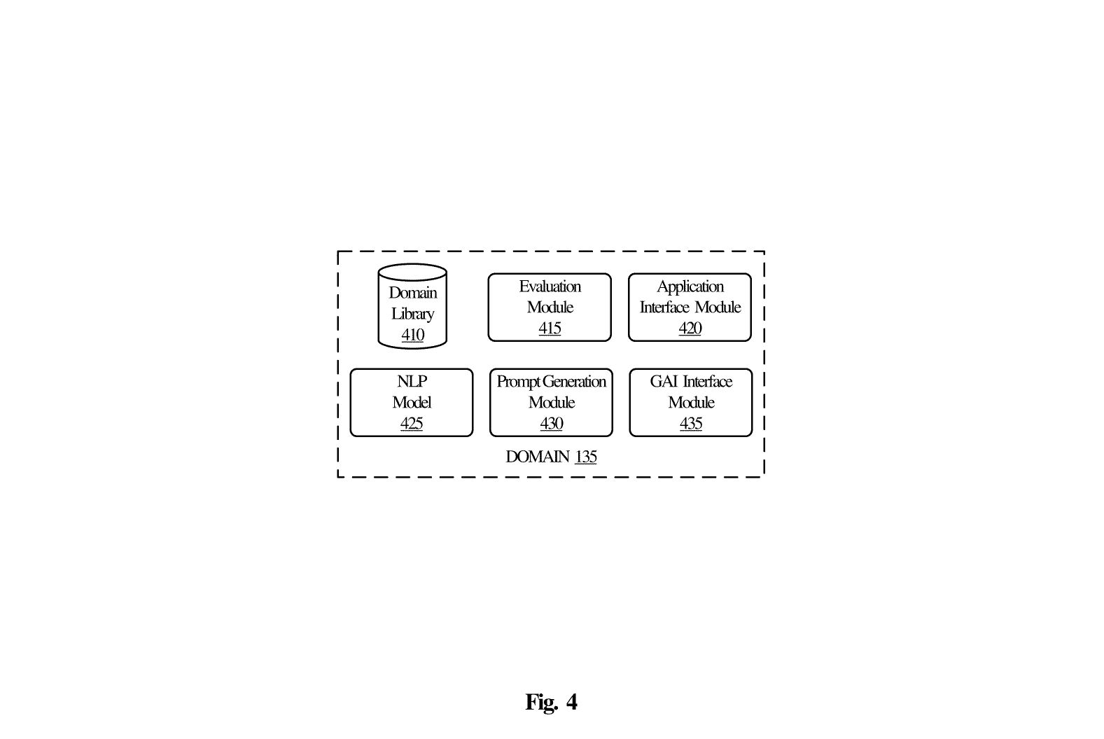

Domains 135 are configured to receive calls from application service 110. For device-specific domains, these calls may include requests for device-specific documentation (which application service 110 may use to generate assistance prompts requesting a guided workflow). To this end, device-specific domains 135 maintain a library (e.g., domain library 410 of FIG. 4) storing documentation associated with the device, including, for example, technical sheets, user manuals, and troubleshooting guides. In some implementations, domains 135 retrieve this documentation and provide it to application service 110 for prompt generation. In other implementations, domains 135 may themselves generate an assistance prompt requesting a guided workflow, as discussed in greater detail in the discussion of process 500 below.

Factory environment 150 is representative of an environment executing industrial processes (e.g., manufacturing, packaging, warehousing, etc.). Factory environment 150 includes a wide range of components for performing the industrial processes, including industrial automation industrial automation devices 155a, 155b, 155c, 155d, 155e, 155f (collectively “industrial automation industrial automation devices 155”) illustrated in FIG. 1. While six industrial automation industrial automation devices 155 are shown in FIG. 1 for simplicity, industrial automation environment 100 may include any number of industrial automation industrial automation devices 155.

Industrial automation devices 155 are representative of various devices that may operate in factory environment 150, including, for example, variable frequency drives (VFDs), direct on line controllers, starters, PLCs, robotic devices, and the like. Operators (users) in factory environment 150 perform many tasks associated with industrial automation devices 155, including selecting the units, designing the system, configuring industrial automation industrial automation devices 155, and maintaining industrial automation devices 155. The users may, in some cases, perform various tasks by interacting with industrial automation devices 155 directly via user device 120. For example, users may configure and troubleshoot industrial automation devices 155 via user device 120 connected to the industrial automation devices 155 (e.g., via a Bluetooth connection, USB connection, near field communication (NFC), etc.).

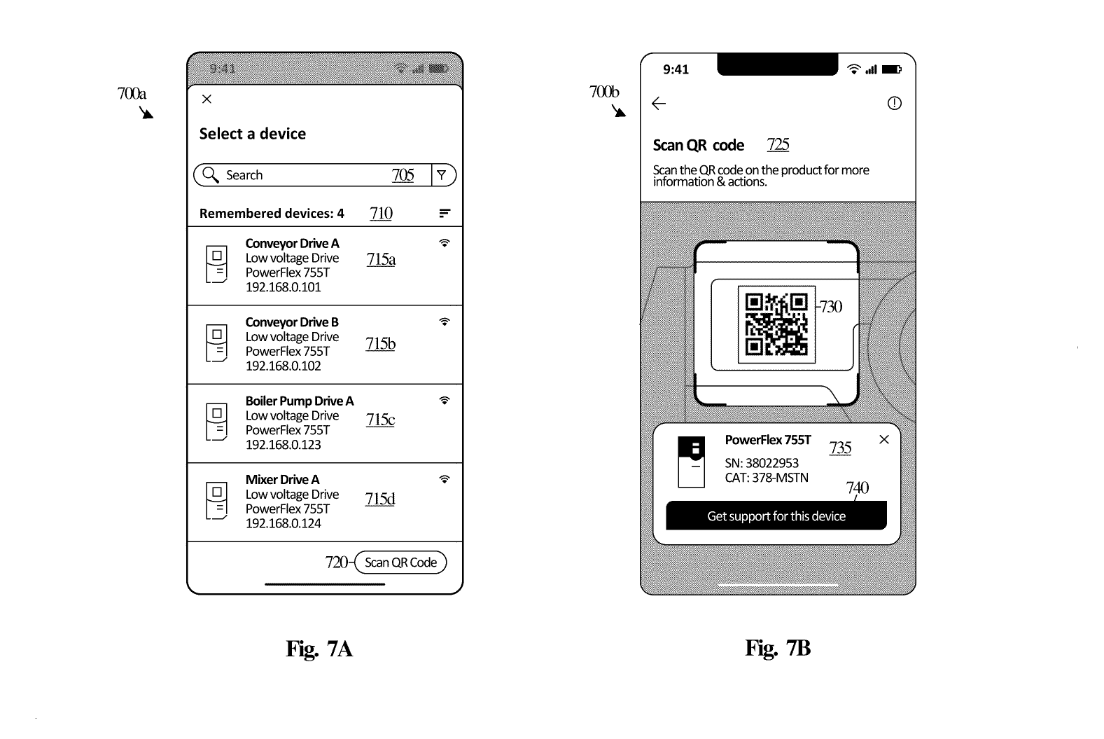

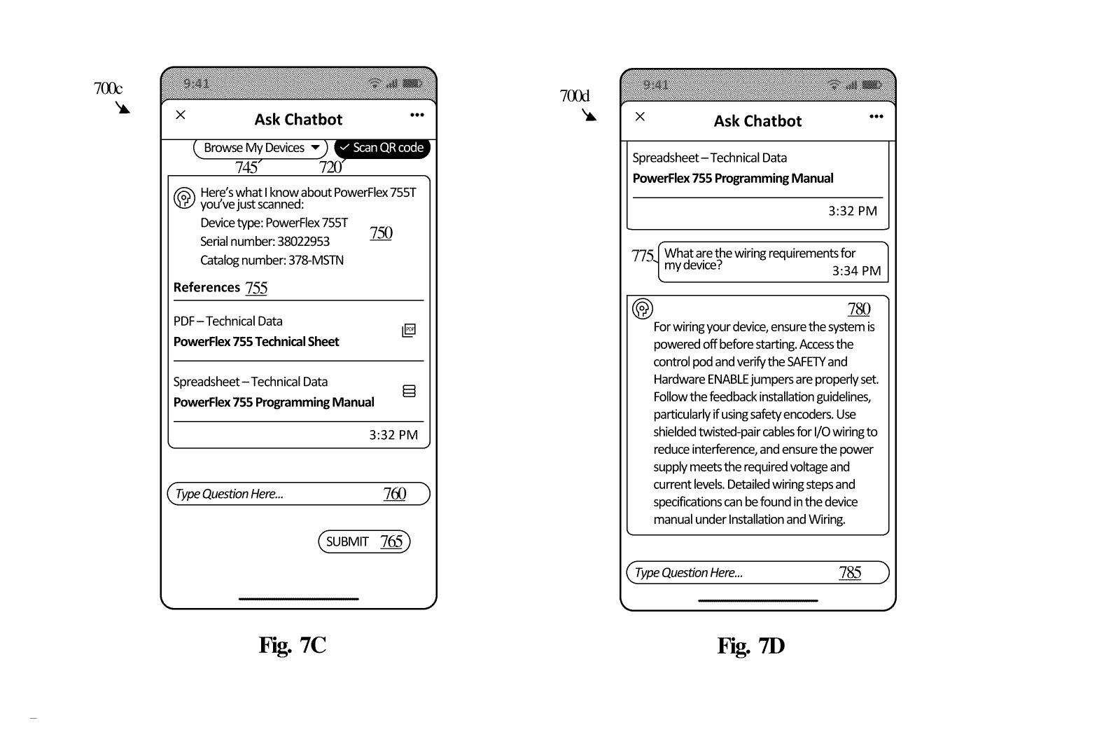

Industrial automation devices 155 may have affixed QR codes. These QR codes may be affixed to industrial automation devices. For example, the QR code may be on a sticker or decal on the casing or packaging of industrial automation device 155. In some embodiments, the QR code may be visible in a screen of industrial automation device 155 (such as in a human interface module). For example, the display screen may automatically or in response to a request, display the QR code. These QR codes may encode information about the device such as catalog numbers, serial numbers, and device types. These QR codes may be scanned by user device 120 to obtain device-specific assistance, as explained further below. An exemplary QR code is represented in element 730 of user interface 700b in FIG. 7B.

GAI model 140 is an artificial intelligence model designed to process and generate natural language text. GAI model 140 may consist of a system of transformer-based neural networks with a vast number of parameters (weights and balances). It is trained on massive amounts of textual data, enabling it to generate relevant responses based on given prompts or input text. In some implementations, GAI model 140 may be fine-tuned using industrial data, such as product specifications and manuals. Alternatively, GAI model 140 may be a generically trained model that utilizes its general training, along with the context of the prompts, to provide assistance specifically tailored to the industrial automation environment 100. Depending on the implementation, GAI model 140 may be hosted and operated by a third party or by an industrial manufacturer, and it may run from cloud infrastructure or one or more data centers.

GAI model 140 is configured to receive prompts from application service 110 and domains 135. Prompts from application service 110 may include troubleshooting prompts requesting assistance for device-specific troubleshooting, domain selection prompts requesting GAI model 140 to identify appropriate domains 135 for responding to a user-submitted query, synthesization prompts requesting GAI model 140 to synthesize responses received from domains 135, and validation prompts requesting GAI model 140 to validate a synthesized response. These various prompts are described in greater detail in co-pending case “SYNTHESIZING DOMAIN-BASED RESPONSES IN INDUSTRIAL AUTOMATION SYSTEMS LEVERAGING GENERATIVE ARTIFICIAL INTELLIGENCE,” attorney docket no. 2024P-227-US, incorporated by reference above.

Generative artificial intelligence (GAI) models (also sometimes known as foundation models) are models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI model that accepts multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

It is noted that FIG. 1 illustrates an implementation that includes one GAI model 140. However, it is noted that in some implementations, industrial automation environment 100 may include multiple GAI models. For instance, one GAI model could handle requests from application service 110, while another GAI model (or several others) manages requests from domains 135.

FIG. 2 illustrates user device 120 in an implementation. User device 120 executes software application 210, which is representative of an industrial chatbot application that assists a user in various tasks such as device troubleshooting. Software application 210 may be stored in memory of user device 120 (represented for example by storage system 803 of FIG. 8) and executed by one or more processors (represented for example by processing system 802 of FIG. 8) of user device 120. Software application 210 provides a user interface in the display of user device 120, to provide users with device information and receive configuration selections. Software application 210 includes display module 250, application interface module 255, and QR code module 260, which are representative of elements of software application 210 performing the functions explained below.

Display module 250 is representative of a module configured to receive user inputs and provide information for display in a user interface. The display module 250 is designed to generate and present a user interface through which a user may interact with the system, including submitting queries to a chatbot (e.g., requests for guided workflows for troubleshooting and maintenance) and receiving responses. Example user interfaces provided by display module 250 are illustrated in FIGS. 7A-7D.

Application interface module 255 is configured to handle communication between user device 120 and application service 110. This module is responsible for transmitting user queries, requests, and any other data from user device 120 to the application service 110, as well as receiving responses, guided workflows, and other relevant information. Application interface module 255 ensures the smooth exchange of data, allowing the system to process user requests and return the necessary information to be displayed via display module 250.

QR code module 260 is configured to resolve scanned QR codes. This module enables the user device 120 to scan QR codes (using a camera on user device 120) located on industrial automation devices. The QR codes on these industrial automation devices 155 contain specific information such as device type, catalog numbers and serial numbers. Upon scanning, QR code module 260 decodes the information and sends it to application service 110, which may use the data for prompt generation, as discussed further below.

FIG. 3 illustrates a detailed view of application service 110. Application service 110 includes domain selection module 310, domain interface module 315, synthesis module 320, validation module 325, natural language processing (NLP) model 330, GAI interface module 335, assistance module 340, user interface (U/I) module 345, and user data repository 350. While these modules and elements are depicted to describe the generation of synthesized domain-based responses, the functionalities described may be incorporated into more or fewer components, software components, hardware components, firmware components, or a combination without departing from the scope and spirit of the present disclosure.

User interface (U/I) module 345 is a module configured to interface with user device 120. U/I module 345 receives user-submitted queries (e.g., request for guided workflows for performing maintenance) from user device 120 and provides responses to user device 120. U/I module 345 may also perform various other user interface functions, including receiving feedback from users and managing user authentication and continuity.

Domain selection module 310 is configured to select appropriate domains 135 for responding to user-submitted queries. Where a user query is a request for a guided workflow for performing maintenance, domain selection module 310 may select a device-specific domain 135 based on a type of device (e.g., “PowerFlex 755T) specified in the user request. In some implementations, domain selection module 310 may select domains based on device information obtained from user device 120 by scanning a QR code on industrial automation device 155. Domain selection module 310 may also use other techniques for selecting domains, such as leveraging GAI model 140.

Domain interface module 315 is configured to interface with domains 135. In some implementations, domain interface module 315 interfaces with domains 135 (selected by domain selection module 310) to obtain documentation for assistance prompts requesting guided workflows from GAI model 140. Specifically, domain interface module 315 submits requests for the documentation to domains 135 and receives the documentation from domains 135. This documentation may include device-specific documentation obtained from device-specific domains 135, and customer-specific documentation retrieved from customer-specific domains 135. This documentation provides contextual information in assistance prompts generated by assistance module 340 discussed below.

Assistance module 340 is configured to generate an assistance prompt for GAI model 140. These assistance prompts may be generated in response to user queries requesting assistance installing industrial automation devices 155, configuring industrial automation devices 155, and performing maintenance on industrial automation devices 155, among other tasks. In some implementations, these assistance prompts may request a guided maintenance and troubleshooting workflow. This assistance prompt may task GAI model 140 with generating a response to the user query. For example, when the user query is a request for a guided workflow, the assistance prompt tasks GAI model 140 with generating a list of prerequisites associated with performing the maintenance, a list of steps for performing the maintenance, and a list of safety precautions for the list of maintenance. The assistance prompt further includes the documentation obtained from domains 135 by domain interface module 315 (as discussed above). Once assistance module 340 generates the assistance prompt, GAI interface module 335 submits the assistance prompt to GAI model 140, as described further below. During guided workflows, assistance module 340 may also track steps marked complete by users and auto-generates a maintenance report upon completion of all the steps.

GAI interface module 335 is a module configured to interface with GAI model 140. GAI interface module 335 performs preprocessing on prompts generated by other modules (e.g., assistance prompts generated by assistance module 340). After preprocessing, GAI interface module 335 submits the refined prompts to GAI model 140 for processing. Once GAI model 140 generates responses, GAI interface module 335 receives these responses and conducts an initial validation, which includes checking for syntax errors and ensuring the responses meet basic correctness criteria before passing them along for further operations.

User data repository 350 is representative of a data repository storing information about users of application service 110. User data repository 350 stores store details such as the user's name, position, organization, location, language preference, and historical conversations, including previously submitted queries and the responses generated for those queries. User data repository 350 may also maintain a list of devices for each user, including industrial automation device 155 that the user has interacted with. Additionally, the repository can store information across various users, capturing historical conversations, pinned chats, and pinned responses. This stored information allows the system to personalize user experiences further, tailor synthesized responses and incorporate conversational elements into responses. Furthermore, user data repository 350 tracks the steps marked complete (e.g., in element 765 of user interface 700d in FIG. 7D) in the list of steps during maintenance workflows.

Synthesis module 320 is configured to synthesize responses received from GAI model 140. The responses received from GAI model 140, as described herein, may be synthesized by synthesis module 320 before providing them to user device 120. For example, where GAI model 140 is prompted separately for general and user-specific prerequisites/safety precautions, synthesis module 320 may synthesize the different responses into a single response.

Validation module 325 is configured to validate the responses received from GAI model 140. Validation module 325 may orchestrate both general evaluation procedures and domain specific evaluation according to some embodiments.

Natural Language Processing (NLP) model 330 is a specialized model designed to process user-submitted natural language queries by analyzing the natural language within them. NLP model 330 may be utilized for domain selection according to some implementations (e.g., by identifying a device type in a natural-language query). Synthesis module 320, validation module 325, and NLP model 330 and various other elements are described in greater detail in co-pending case “SYNTHESIZING DOMAIN-BASED RESPONSES IN INDUSTRIAL AUTOMATION SYSTEMS LEVERAGING GENERATIVE ARTIFICIAL INTELLIGENCE,” attorney docket no. 2024P-227-US, incorporated by reference above.

FIG. 4 is a detailed view of domain 135, which is representative of each of domains 135a, 135b, 135c, 135d, 135e, 135f illustrated in FIG. 1. Domain 135 includes domain library 410, evaluation module 415, application interface module 420, NLP model 425, prompt generation module 430, and GAI interface module 435. While these modules and elements are depicted to describe the operation of domain 135, the functionalities described may be incorporated into more or fewer components, software components, hardware components, firmware components, or a combination without departing from the scope and spirit of the present disclosure.

Domain library 410 is representative of a repository storing documentation associated with each domain. For example, where domain 135 is a domain for an industrial automation device, domain library 410 may include technical sheets, programming manuals, troubleshooting guides, installation guides, and user training manuals for industrial automation device 155, among other types of documentation. Where domain 135 is a customer-specific domain, domain library 410 may include customer-specific safety documentation, and customer specific maintenance procedures, among other types of documentation. Documentation may be retrieved by application interface module 420 and provided to application service 110 in response to requests (e.g., where application service requests the documentation for generation of assistance prompts for guided workflow). In other implementations, prompt generation module 430 of domain 135 may itself utilize documentation from domain library 410 to generate assistance prompts, as discussed further below.

Application interface module 420 is a module configured to interface with application service 110. Application interface module 420 receives requests from application service 110 (e.g., requests for device-specific documentation or customer-specific safety documentation) and provides generated domain-specific responses (e.g., documentation retrieved from domain library 410 described above) to application service 110.

Prompt generation module 430 is a module configured to generate domain prompts to GAI model 140. It is noted that, while application service 110 may generate assistance prompts in some implementations (as described in FIG. 3 above), in other implementations domain 135 may itself generate and submit the assistance prompts. These assistance prompts may be substantially the same as the assistance prompt described above with respect to assistance module 340.

GAI interface module 435 is a module configured to interface with GAI model 140. GAI interface module 435 performs preprocessing on prompts generated by prompt generation module 430. After preprocessing, GAI interface module 435 submits the refined prompts to GAI model 140 for processing. Once GAI model 140 generates responses, GAI interface module 435 receives these responses and conducts an initial validation, which includes checking for syntax errors and ensuring the responses meet basic correctness criteria before passing them along for further operations. In implementations in which domains 135 generate assistance prompts, GAI interface module 435 submits the assistance prompts to GAI model 140 and receives the generated response. Application interface module 420 then provides the GAI-generated responses to application service 110.

Evaluation module 415 is a module configured to provide domain-specific evaluation procedures to application service 110. Evaluation module 415 may maintain descriptions of appropriate domain procedures that may be used by application service 110 to perform the domain-specific evaluation discussed above.

NLP model 425 is a model designed to process the domain-specific calls by analyzing the natural language within them. NLP model 425 may enable domain 135 to generate domain-specific responses to various types of requests from application service 110. NLP model 425, evaluation module 415, and various other elements are described in greater detail in co-pending application “SYNTHESIZING DOMAIN-BASED RESPONSES IN INDUSTRIAL AUTOMATION SYSTEMS LEVERAGING GENERATIVE ARTIFICIAL INTELLIGENCE,” attorney docket no. 2024P-227-US, incorporated by reference above.

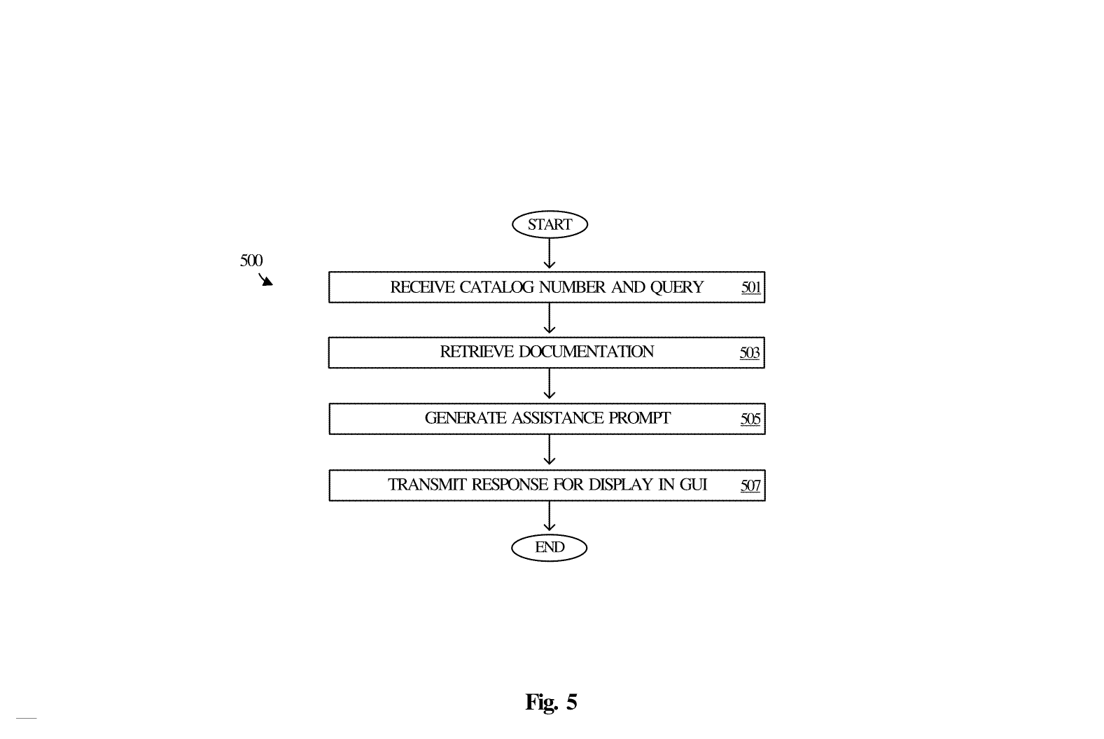

FIG. 5 illustrates a guided industrial assistance process, represented by process 500. Process 500 is employed by one or more computing devices, an example of which is provided by computing system 801 of FIG. 8. Process 500 may be implemented in program instructions (software and/or firmware) by one or more processors of the computing device. The program instructions direct the computing device to operate as follows, referring to the steps in FIG. 5.

Step 501 of process 500 is receiving, at an application service, a catalog number for industrial automation device 155 and a user query requesting assistance with respect to industrial automation device 155. Step 501 is performed by application service 110, and in particular by U/I module 345. The catalog number is obtained via the GUI (e.g., user interface 700b of FIG. 7B) of user device 120 by scanning the QR code affixed to industrial automation device 155. FIG. 7B illustrates that a user on user device 120 scans the QR code (represented by element 730) affixed to industrial automation device 155. The QR code encodes a serial number, catalog number, and device type of industrial automation device 155, in some implementations (noting that in various implementations, the QR code may encode only a portion of these elements and/or additional elements). While the catalog number may identify the device model of industrial automation device 155, the serial number may uniquely identify the specific device itself. The device type may specify the device family of industrial automation device 155 (e.g., “PowerFlex 755T”). User device 120, upon scanning the QR code, decodes it to obtain the serial number, catalog number and device type. In some implementations, user device 120 may transmit each of these values to application service 110 in step 501.

The user query of step 501 may include one or more of: one or more of: a request for assistance performing maintenance on industrial automation device 155, a request for assistance installing industrial automation device 155, and a request for assistance configuring industrial automation device 155, in various implementations. This query is input by the user in the GUI (e.g., in element 760 of user interface 700c of FIG. 7C). In some implementations, the query may be a natural language query (e.g., “Provide instructions for installing my PowerFlex 755T”).

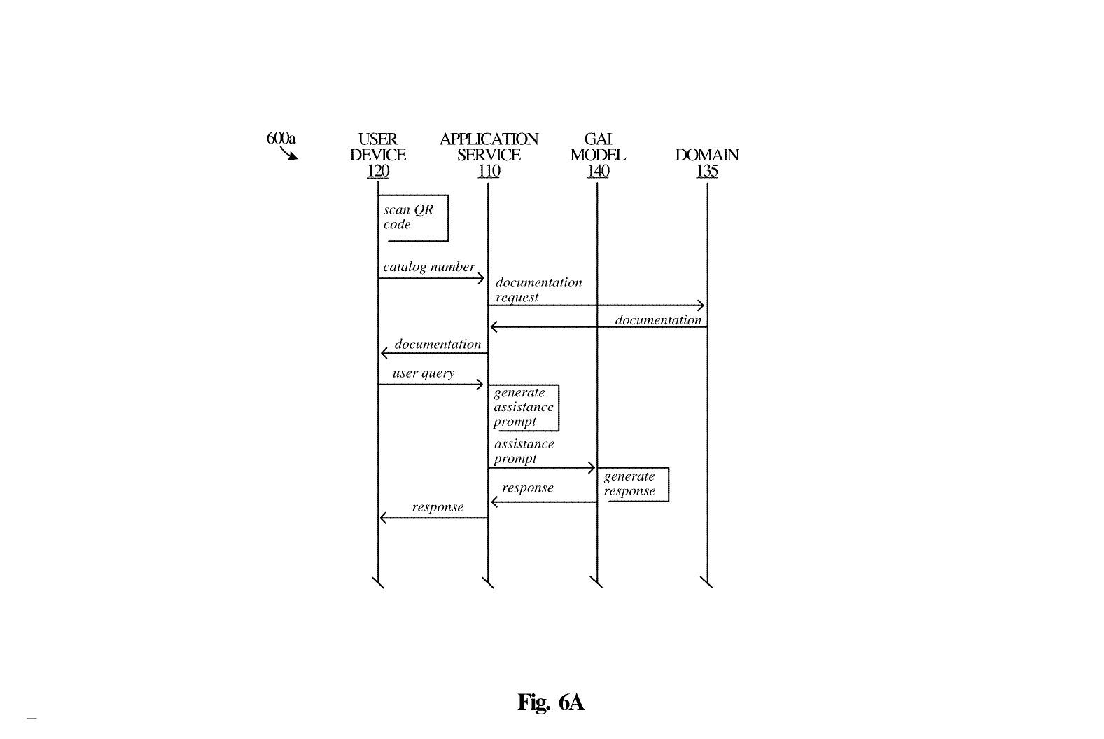

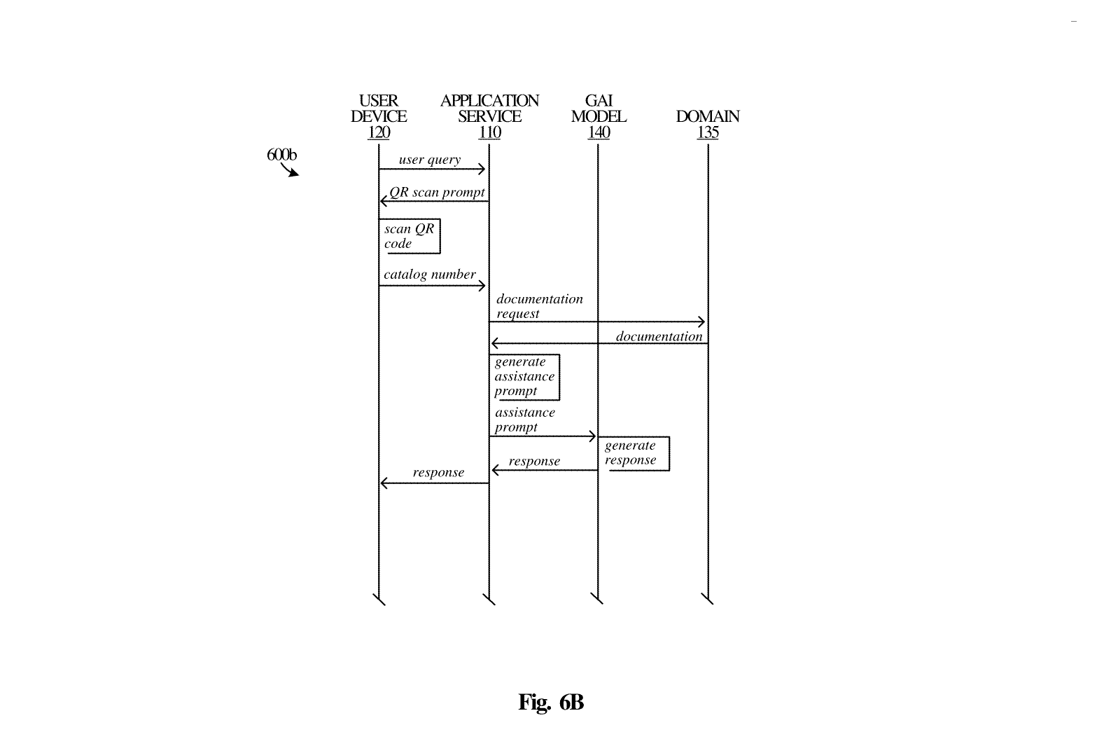

In various implementations, user device 120 may transmit the user query to application service 110 concurrently with the catalog number, or after the catalog number (as illustrated in FIG. 6A) or before the catalog number (as illustrated in FIG. 6B).

Step 503 of process 500 is retrieving, based on the catalog number, documentation associated with industrial automation device 155. Step 503 is performed by application service 110, and in particular by domain interface module 315. Step 503 may include identifying a specific model of industrial automation device 155 based on the catalog number. It is noted that a given device family (e.g., a device type) may encompass multiple different device models. For example, the “PowerFlex 755T” device family may encompass various specific models of devices, each having particular characteristics such as voltage rating, input type, and enclosure type. Each of these device models may be uniquely identifiable by catalog numbers. Accordingly, application service 110 may determine the specific model of industrial automation device 155 based on the catalog number.

Application service 110 retrieves documentation for industrial automation device 155 for the specific model identified by the catalog number. This documentation is relevant for responding to the user query, and may include at least a portion of one or more of: a technical sheet for industrial automation device 155, a programming manual for industrial automation device 155, a troubleshooting guide for industrial automation device 155, an installation guide for industrial automation device 155, and a user training manual for industrial automation device 155. This documentation may be included in an assistance prompt as contextual information for industrial automation device 155, as explained further below.

In some implementations, application service 110 may retrieve the documentation from a device-specific domain 135. In particular, domain selection module 310 of application service 110 may identify the appropriate device-specific domain 135 based on the catalog number. Domain interface module 315 then submits a request for the documentation to the selected domain 135. Domain 135 retrieves the documentation from domain library 410 (see FIG. 4) and returns the documentation to application service 110 (via domain interface module 315).

Step 505 of process 500 is generating an assistance prompt for GAI model 140. Step 505 is performed by application service 110, and more specifically by assistance module 340. The assistance prompt is designed to elicit a response from GAI model 140, and tasks the GAI model with generating a response to the user query. The assistance prompt includes the documentation retrieved at step 503. The assistance prompt may also include metadata associated with industrial automation device 155 identified by application service 110 based on the catalog number. The metadata may include, for example, a voltage rating, an input type, and an enclosure type of industrial automation device 155, among other defining features. The documentation and metadata are used by GAI model 140 as contextual information for responding to the prompt. For example, where the user query requests assistance installing industrial automation device 155, GAI model 140 may process the installation guide with the relevant information to generate the response with the relevant information for responding to the user query. Application service 110 (in particular, GAI interface module 335) submits the assistance prompt to GAI model 140. GAI model 140 generates a response to the user query and returns the generated response to application service 110 via GAI interface module 335.

Step 507 of process 500 is transmitting the response to user device 120 for display. Step 507 is performed by application service 110, and more specifically by U/I module 345. After application service 110 receives the generated response from GAI model 140, application service 110 transmits it to user device 120 for display. User device 120 then displays the model generated response in a graphical user interface, as shown for example in element 780 of user interface 700d in FIG. 7D.

FIG. 6A illustrates an operational sequence of an application of process 500 in the context of industrial automation environment 100 in an implementation, represented by sequence 600a. Sequence 600a includes user device 120, application service 110, GAI model 140, and domain 135.

To begin, user device 120 scans the QR code (represented by element 730 of FIG. 7B) affixed to industrial automation device 155 (as illustrated, by way of example, in user interface 700b of FIG. 7B). User device 120 transmits, to application service 110, the catalog number for industrial automation device 155. This catalog number is obtained by user device 120 from the QR code, as discussed above in step 501 of process 500. Application service 110 submits a documentation request to domain 135, and domain 135 responds to application service 110 with the documentation. Domain 135 may be selected based on the catalog number, and the documentation may be specific to the device model associated with an industrial automation device 155, as discussed in greater detail above in step 503 of process 500. Application service 110 transmits the documentation to user device 120 for display in a GUI of user device 120 (as illustrated in element 755 of user interface 700c of FIG. 7C). User device 120 transmits a user query to application service 110, as discussed above in step 501 of process 500. Application service 110 generates an assistance prompt, and submits the assistance prompt to GAI model 140, as discussed in step 505 of process 500 above. GAI model 140 transmits the generated response to application service 110, and application service 110 transmits the response to user device 120 for display, as discussed above in step 507 of process 500.

FIG. 6B illustrates an operational sequence of an application of process 500 in the context of industrial automation environment 100 in an implementation, represented by sequence 600b. Sequence 600b includes user device 120, application service 110, GAI model 140, and domain 135.

To begin user device 120 submits a user query to application service 110 (as discussed above in step 501 of process 500). Application service 110 prompts user device 120 to scan a QR code on industrial automation device 155 (as illustrated in element 725 of user interface 700b in FIG. 7B). User device 120 scans the QR code, resolves the catalog number based on the QR code, and transmits the catalog number to application service 110 (as discussed above in step 501 of process 500). Application service retrieves the documentation by submitting a documentation request to domain 135 and receiving the documentation from domain 135, as discussed above in step 503 of process 500. Application service 110 generates an assistance prompt, and submits the assistance prompt to GAI model 140, as discussed above in step 505 of process 500. GAI model 140 generates a response and transmits the response to application service 110. Application service 110 transmits the response to user device 120 for display, as discussed above in step 507 of process 500.

FIGS. 7A-7D illustrate user interfaces 700a, 700b, 700c, 700d of user device 120 (of FIG. 1) according to some implementations. User interfaces 700a, 700b, 700c, 700d illustrate a sequence of interfaces displayed in a screen of user device 120 for a user performing maintenance on industrial automation device 155. It is noted that user interfaces 700a, 700b, 700c, 700d illustrate some examples; in other implementations user interfaces on user device 120 may have different arrangements, different elements, or additional or fewer elements. In some implementations, user interfaces 700a-700d may be displayed on a touchscreen of user device 120, allowing users to select elements by tapping. In other implementations, these interfaces may appear on other display types, where users can select elements using mouse or keyboard inputs.

FIG. 7A illustrates user interface 700a in an implementation. User interface 700a includes element 710, which is representative of a device list of industrial automation devices 155 that a user has interacted with (“Remembered Devices”). For example, when a user connects to an industrial automation device 155 via Bluetooth, USB, NFC, or by scanning a QR code, application service 110 may add an entry to the device list for the user. This device list may be maintained in user data repository 350 (of FIG. 3) in associated with the user. The exemplary device list in user interface 700a includes four entries for remembered devices, represented by elements 715a, 715b, 715c, and 715d. A user may select one of elements 715a, 715b, 715c, 715d to obtain assistance with respect to the associated industrial automation device 155. A user may also search for a specific device in the list in the text input field of element 705.

Element 720 represents a selectable option for user to scan a QR code on industrial automation device 155 (as discussed above with respect to step 501 of process 500). A user may select element 720, for example, when interacting with a new industrial automation device 155 that is not included in the device list of element 710.

FIG. 7B illustrates user interface 700b in an implementation. User interface 700b is displayed when the user selects the “Scan QR Code” element 720 of user interface 700a. Element 725 represents a prompt to the user to scan the QR code. Element 730 represents a visual image of the QR code on industrial automation device 155 obtained by a camera of user device 120. This QR code may be affixed to the industrial automation device 155, including, for example, on a casing of industrial automation device 155, on a screen on industrial automation device 155 (such as on a Human Interface Module (HIM)), or on packaging of industrial automation device 155.

Element 735 displays information obtained from the QR code, including the catalog number (“CAT”), serial number (“SN”) and device type (“PowerFlex 755T”). This information may be encoded in the QR code, using a standardized encoding format such as alphanumeric text or binary data. The QR code may store the data in a structured format where each segment represents a different piece of information (e.g., the catalog number, serial number, and device type). When scanned by a user device, the QR code reader decodes this information and parses it to obtain the information displayed in element 735. Element 740 represents an option for a user to get support for the scanned device. Upon selection of element 740, user device 120 transmits the catalog number, serial number, and device type to application service 110, as described above in relation to step 501 of process 500. Upon receiving this information, application service 110 may identify that the user is interacting with a new device (based on the serial number) and add an entry to the device list (i.e., as represented in element 710 of user interface 700a) associated with the user in user data repository 350. Accordingly, when a user scans a QR code on an industrial automation device 155, application service 110 may include the scanned device in the user’s device list such that the user may interact with the scanned device in the future.

FIG. 7C illustrates user interface 700c in an implementation. User interface 700c may be displayed upon selection of a selection of element 740 of user interface 700b (requesting support for industrial automation device 155). Element 720, displaying the prompt to scan the QR code, is shown in bold, indicating that the user is obtaining support for the scanned device from user interface 700b. Element 745 represents a selectable option to view the device list (represented by element 710 of FIG. 7A). Upon selection of element 745, application service 110 transmits the device list to user device 120 for display (as shown in FIG. 7A), where the device list may include the newly scanned device from FIG. 7B.

Returning to FIG. 7C, element 750 illustrates an initiation of a chatbot conversation with a display of the information obtained by the QR code (i.e., the serial number, catalog number, and device type). Element 755 illustrates documentation for industrial automation device 155 obtained by application service, as discussed above in relation to step 503 of process 500. A user may select the titles displayed in element 755 (in this case “PDF-technical data” and “Spreadsheet – Technical Data”) to view the associated documents. Element 760 illustrates a text input field in which a user may input a user query associated with the device (where the user query is discussed above in the discussion of step 501 of process 500). Element 765 represents a selectable button for the user to submit the question input in element 760.

FIG. 7D illustrates user interface 700d in an implementation. User interface 700d may be displayed after a user has submitted a user query in user interface 700c. Element 775 displays the user query input by the user, and element 780 represents the response received from application service. This response is generated using assistance from GAI model 140, as discussed above in relation to steps 505 and 507 of process 500. Element 785 illustrates a text input field in which a user may input a follow-up query.

FIG. 8 illustrates a computing system 801 that is representative of any system or collection of systems in which the various processes, programs, services, and scenarios disclosed herein may be implemented. Examples of the computing system 801 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

The computing system 801 may be implemented as a single apparatus, system, or device or may be implemented in a distributed manner as multiple apparatuses, systems, or devices. The computing system 801 includes, but is not limited to, a processing system 802, a storage system 803, software 805, a communication interface system 807, and a user interface system 809. The processing system 802 is operatively coupled with the storage system 803, the communication interface system 807, and the user interface system 809.

The processing system 802 loads and executes software 805 from the storage system 803. The software 805 includes and implements the industrial assistance processes 806, which is (are) representative of the application service processes discussed with respect to the preceding figures, such as the process 500 of FIG. 5. When executed by the processing system 802, the software 805 directs the processing system 802 to operate as described herein for at least the various processes, operational scenarios, and sequences discussed in the foregoing implementations. The computing system 801 may optionally include additional devices, features, or functionality not discussed for purposes of brevity.

Referring still to FIG. 8, the processing system 802 may comprise a microprocessor and other circuitry that retrieves and executes the software 805 from the storage system 803. The processing system 802 may be implemented within a single processing device but may also be distributed across multiple processing devices or sub-systems that cooperate in executing program instructions. Examples of the processing system 802 include general purpose central processing units, graphical processing units, application specific processors, and logic devices, as well as any other type of processing device, combinations, or variations thereof.

The storage system 803 may comprise any computer-readable storage media device readable by the processing system 802 and capable of storing the software 805. The storage system 803 may include volatile and nonvolatile, removable, and non-removable media implemented in any method or technology for storage of information, such as computer readable software instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated or transitory signal.

In addition to computer-readable storage media, in some implementations the storage system 803 may also include computer readable communication media over which at least some of the software 805 may be communicated internally or externally. The storage system 803 may be implemented as a single storage device but may also be implemented across multiple storage devices or sub-systems co-located or distributed relative to each other. The storage system 803 may comprise additional elements, such as a controller, capable of communicating with the processing system 802 or possibly other systems.

The software 805 (including industrial assistance processes 806) may be implemented in program instructions and among other functions may, when executed by the processing system 802, direct the processing system 802 to operate as described with respect to the various operational scenarios, sequences, and processes illustrated herein. For example, software 805 may include program instructions for implementing an industrial assistance process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. The software 805 may also comprise firmware or some other form of machine-readable processing instructions executable by the processing system 802.

In general, the software 805 may, when loaded into the processing system 802 and executed, transform a suitable apparatus, system, or device (of which the computing system 801 is representative) overall from a general-purpose computing system into a special-purpose computing system customized to support an application service in an optimized manner. Indeed, encoding software 805 on storage system 803 may transform the physical structure of the storage system 803. The specific transformation of the physical structure may depend on various factors in different implementations of this description. Examples of such factors may include, but are not limited to, the technology used to implement the storage media of the storage system 803 and whether the computer-storage media are characterized as primary or secondary storage, as well as other factors.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or," in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for", but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for operating an application service comprising:
receiving, at the application service and from a user device:
a catalog number of an industrial automation device, wherein the catalog number is obtained via a graphical user interface (GUI) executing on the user device by scanning a quick-response (QR) code affixed to the industrial automation device, and
a user query requesting assistance with respect to the industrial automation device;
retrieving, based on the catalog number, documentation associated with the industrial automation device;
generating an assistance prompt designed to elicit a response from a general artificial intelligence (GAI) model, wherein the assistance prompt tasks the GAI model with generating a response to the user query, and wherein the assistance prompt includes the documentation; and
transmitting the response to the user device for display via the GUI.

2. The computer-implemented method of claim 1, further comprising:
selecting, based on the catalog number, a device-specific domain from a plurality of domains, wherein each of the plurality of domains is directed to a specific aspect of an industrial automation environment, and wherein the retrieving the documentation comprises submitting a request for the documentation to the device-specific domain.

3. The computer-implemented method of claim 1, further comprising:
receiving, at the application service and from the user device, a serial number for the industrial automation device, wherein the serial number is obtained by the scanning the QR code; and
adding an entry for the industrial automation device to a device list comprising a plurality of entries for industrial automation devices a user has interacted with; and
transmitting the device list to the user device for display via the GUI.

4. The computer-implemented method of claim 1, wherein the user query is a request for assistance performing maintenance on the industrial automation device, the method further comprising:
transmitting, to the user device in response to the user query, instructions to display a prompt to scan the QR code, wherein receiving the catalog number is in response to the prompt to scan the QR code.

5. The computer-implemented method of claim 1, wherein the user query comprises one or more of: a request for assistance performing maintenance on the industrial automation device, a request for assistance installing the industrial automation device, and a request for assistance configuring the industrial automation device.

6. The computer-implemented method of claim 1, further comprising:
transmitting the documentation to the user device for display via the GUI, wherein the documentation comprises at least a portion of one or more of: a technical sheet for the industrial automation device, a programming manual for the industrial automation device, a troubleshooting guide for the industrial automation device, an installation guide for the industrial automation device, and a user training manual for the industrial automation device.

7. The computer-implemented method of claim 1, wherein the QR code encodes the catalog number for the industrial automation device, a serial number of the industrial automation device, and a device type for the industrial automation device.

8. A system comprising:
one or more processors; and
one or more memories operably coupled to the one or more processors and having stored thereon software instructions that, upon execution by the one or more processors, cause the one or more processors to:
receive, at an application service and from a user device:
a catalog number of an industrial automation device, wherein the catalog number is obtained via a graphical user interface (GUI) executing on the user device by scanning a quick-response (QR) code affixed to the industrial automation device, and
a user query requesting assistance with respect to the industrial automation device;
retrieve, based on the catalog number, documentation associated with the industrial automation device;
generate an assistance prompt designed to elicit a response from a general artificial intelligence (GAI) model, wherein the assistance prompt tasks the GAI model with generating a response to the user query, and wherein the assistance prompt includes the documentation; and
transmit the response to the user device for display via the GUI.

9. The system of claim 8, wherein the instructions comprise further instructions that, upon execution by the one or more processors, cause the one or more processors to:
select, based on the catalog number, a device-specific domain from a plurality of domains, wherein each of the plurality of domains is directed to a specific aspect of an industrial automation environment, and wherein the retrieving the documentation comprises submitting a request for the documentation to the device-specific domain.

10. The system of claim 8, wherein the instructions comprise further instructions that, upon execution by the one or more processors, cause the one or more processors to:
receive, at the application service and from the user device, a serial number for the industrial automation device, wherein the serial number is obtained by the scanning the QR code; and
add an entry for the industrial automation device to a device list comprising a plurality of entries for industrial automation devices a user has interacted with; and
transmit the device list to the user device for display via the GUI.

11. The system of claim 8, wherein the user query is a request for assistance performing maintenance on the industrial automation device, and wherein the instructions comprise further instructions that, upon execution by the one or more processors, cause the one or more processors to:
transmit, to the user device in response to the user query, instructions to display a prompt to scan the QR code, wherein receiving the catalog number is in response to the prompt to scan the QR code.

12. The system of claim 8, wherein the user query comprises one or more of: a request for assistance performing maintenance on the industrial automation device, a request for assistance installing the industrial automation device, and a request for assistance configuring the industrial automation device.

13. The system of claim 8, wherein the instructions comprise further instructions that, upon execution by the one or more processors, cause the one or more processors to:
transmit the documentation to the user device for display via the GUI, wherein the documentation comprises at least a portion of one or more of: a technical sheet for the industrial automation device, a programming manual for the industrial automation device, a troubleshooting guide for the industrial automation device, an installation guide for the industrial automation device, and a user training manual for the industrial automation device.

14. The system of claim 8, wherein the QR code encodes the catalog number for the industrial automation device, a serial number of the industrial automation device, and a device type for the industrial automation device.

15. A method comprising:
scanning, by a user device, a quick-response (QR) code affixed to an industrial automation device;
resolving, by the user device, a catalog number of the industrial automation device from the QR code;
transmitting, by the user device and to an application service:
the catalog number, and
a user query requesting assistance with respect to the industrial automation device;
retrieving, by the application service and based on the catalog number, documentation associated with the industrial automation device;
generating, by the application service, an assistance prompt designed to elicit a response from a general artificial intelligence (GAI) model, wherein the assistance prompt tasks the GAI model with generating a response to the user query, and wherein the assistance prompt includes the documentation;
transmitting the response to the user device for display; and
displaying, by the user device, the response in a graphical user interface (GUI) of the user device.

16. The method of claim 15, further comprising:
selecting, by the application service and based on the catalog number, a device-specific domain from a plurality of domains, wherein each of the plurality of domains is directed to a specific aspect of an industrial automation environment, and wherein the retrieving the documentation comprises submitting a request for the documentation to the device-specific domain.

17. The method of claim 15, further comprising:
receiving, by the application service and from the user device, a serial number for the industrial automation device, wherein the serial number is obtained by the scanning the QR code; and
adding, by the application service, an entry for the industrial automation device to a device list comprising a plurality of entries for industrial automation devices a user has interacted with;
transmitting, by the application service, the device list to the user device; and
displaying, by the user device, the device list in the GUI.

18. The method of claim 15, further comprising:
wherein the user query is a request for assistance performing maintenance on the industrial automation device, the method further comprising:
transmitting, by the application service and to the user device in response to the user query, instructions to display a prompt to scan the QR code, wherein receiving the catalog number is in response to the prompt to scan the QR code; and
displaying, by the user device, the prompt to scan the QR code.

19. The method of claim 15, further comprising: wherein the user query comprises one or more of: a request for assistance performing maintenance on the industrial automation device, a request for assistance installing the industrial automation device, and a request for assistance configuring the industrial automation device.

20. The method of claim 15, further comprising:
transmitting, by the application service and to the user device, the documentation to the user device for display, wherein the documentation comprises at least a portion of one or more of: a technical sheet for the industrial automation device, a programming manual for the industrial automation device, a troubleshooting guide for the industrial automation device, an installation guide for the industrial automation device, and a user training manual for the industrial automation device; and
displaying, by the user device, the documentation in the GUI.
